(19) United States
(12) Patent Application Publication
(10) Pub. No.: US 2021/0022294 A1
(43) Pub. Date: Jan. 28, 2021

(54) PICK UP DEVICE FOR CUT PLANTS TREATMENT MACHINE AND MACHINE

(71) Applicant: KUHN S.A., Saverne (FR)

(72) Inventors: Christian GANTZER, Woustviller (FR); Mickael SCHWER, Bourscheid (FR)

(73) Assignee: KUHN S.A., Saverne (FR)

(21) Appl. No.: 16/926,890

(22) Filed: Jul. 13, 2020

(30) Foreign Application Priority Data
Jul. 22, 2019 (FR) 19 08276

(51) Int. Cl. A01D 80/00; A01D 78/14

(52) U.S. Cl. CPC A01D 80/00; A01D 78/14

(57) ABSTRACT

Collection device for cut plant processing machine and corresponding machine This invention relates to the a collection device (2), comprising, on the one hand, a frame (3) and an elongated rotor (5) guided in rotation in relation to the frame (3) about a longitudinal axis (AL), a plurality of raking tines (7) arranged by groups of three or more being mounted on rotor (5), each group of tines (7) being located in its own plane perpendicular to the longitudinal axis (AL), these different planes being laid out along the said longitudinal axis (AL), and, on the other hand, a plurality of deflectors (9) extending at least partially about rotor (5) and spaced out in the direction of the longitudinal axis (AL), the spacing between the two adjacent deflectors (9) being adapted for the passage of the tines (7) of a group during rotation of rotor (5), and in the mounted state the said deflectors (9) being connected to frame (3) by the intermediary of at least one first means of attachment (10). Device (2) characterized in that at least one movable part of at least one of the deflectors (9) is connected to the frame (3) by an articulated connection (11) which allows the said movable part at least a swivel movement inducing a disengagement in relation to rotor (5).

This invention relates to the field of agricultural machines, more specifically agricultural machines for the processing of cut plants, intended, for example, for collection, swathing, tedding, and/or baling of cut plants lying on the ground. These harvesting machines are equipped with a collection device that retrieves cut plants lying on the ground when the machine is driven in a forward direction of travel. Such a collection device is, for example, known as a “pick-up” type in agriculture.

In this context, the main purposes of the invention are an improved collection device and an agricultural machine of the type mentioned here above with such an improved collection device.

The processing machines (self-propelled or towed) concerned by this solution generally comprise a frame which supports at least one set of active components. This set of active components comprises at least one collection device with a frame (possibly with adjustable height and, if necessary, angle).

Such a collection device comprises a rotor which is guided in rotation relative to the frame and which can be driven in rotation. On this rotor are mounted raking tines which collect the plants from ground level and move them upwards and to the rear. These tines are advantageously detachably attached to the rotor and, when viewed from above, are substantially oriented perpendicular to the rotor axis. These tines are further arranged in groups of three or more, the tines of each group being located on a specific transverse plane, preferably perpendicular to the longitudinal axis of the rotor. Their direction of rotation is preferably such that at the low part of the rotor the tines move towards the front. The low part of the rotor refers to the part of the rotor below the longitudinal axis of the rotor when the device is in the operational position.

In addition, the collection device comprises guidance deflectors which are rigidly attached to the frame in normal times, and especially when operating in the mounted state.

In such a case, each deflector extends along a transverse plane, preferably perpendicular to the longitudinal axis of the rotor.

The deflectors are arranged one next to another in a direction parallel to the rotor axis with a mutual spacing allowing the passage of the tines of a group, thus forming a cylindrical partially-open enclosure around the rotor.

Preferably, each deflector partially surrounds the rotor and guides the plants onto an outer wall during its movement from the ground until it is out of the grip of the tines. The plants therefore slide on the outer walls of the deflectors during their movement, thus keeping most of the plants away from the rotor. The outer wall of each deflector is smooth to prevent forage from catching, which could lead to intrusion of plants between the deflectors. The presence of plants at the rotor during rotation can cause plants to wrap around the rotor, causing friction and thus slowing down the rotation of the rotor or even blockage or breakage of the rotor.

Documents U.S. Pat. Nos. 3,226,921, 1,877,519 and EP 1 976 370, for example, already disclose embodiments of collection devices in which the deflectors are in the form of strips bent in a C-shape, which are detachably connected to the frame at the two free ends of their C-shaped body.

In these embodiments, each deflector surrounds the rotor on at least one part, for example, on at least half of its circumference from a side view, and preferably around more than three-quarters of its circumference. The frame (possibly providing additional C-shaped strips) and each deflector, together form a circular loop encircling the rotor. The deflectors maintain a distance between the plants and the rotor and thus prevent the plants from coming into contact with the rotor: the rotor is thus provided with a circumferential cylindrical enclosure with slots in which the tines can move.

The rigid, preferably detachable attachment of the deflector to the frame can be obtained, for example, by nut and bolt attachment, screwing, mechanical engagement or the like, with one of these means of attachment possibly serving to block or lock another means of attachment.

It is at times necessary to intervene on the rotor, for example, to remove and/or replace a bearing, a bearing system, and/or a tine. Working on the rotor implies access to the rotor, or even to the inside of the rotor, or to the tine fixings on the rotor. To access the rotor, it is however necessary to remove at least one and generally several deflector(s).

For this purpose, the current state of the art proposes detachable or separable means of attachment, generally located at the ends of each deflector (see the US and EP documents mentioned above).

The dismantling of deflectors, followed by their reassembly, thus induces a drawn-out intervention time and requires the removal and handling of the removed parts. In addition, if one of the means of attachment is located at the lower end of the deflector, this intervention can also be difficult and complex.

The purpose of this invention is to provide a collection device of the above-mentioned type permitting easy and rapid access to at least one location on the rotor, advantageously to the attachments of at least some raking tines, or even inside the rotor, preferably without requiring the dismantling of one or more deflector(s).

For this purpose, the invention has as its subject matter a collection device comprising, on the one hand, a frame and an elongated rotor guided in rotation with respect to the frame about a longitudinal axis, with a plurality of raking tines arranged in groups of three, or more, being mounted on the rotor, each group of tines being located on its own plane perpendicular to the longitudinal axis, these different planes being arranged along the said longitudinal axis, and, on the other hand, a plurality of deflectors extending at least partially around the rotor and spaced out in the direction of the longitudinal axis, the spacing between two adjacent deflectors being adapted for the passage of the tines of a group during rotation of the rotor, and said deflectors being, in the mounted state, connected to the frame via at least one first means of attachment, a device characterized in that at least one movable part of at least one of the deflectors is connected with the frame by an articulated connection which allows at least a swiveling motion of said movable part leading to disengagement from the rotor, said articulated connection being arranged and configured in such a way that, after detachment of the first means of attachment, at least the movable part of the relevant deflector can be swiveled about a swivel axis so that the or each relevant deflector is in a disengaged state.

The subject matter of the invention furthermore relates to an agricultural machine comprising such a collection device, a deflector for such a device and a method of at least partially disengaging a rotor of an agricultural machine of the aforementioned type, as mentioned here below.

The invention will be better understood thanks to the description here below, which refers to preferred embodiments, given as non-limiting examples, and which are explained with reference to appended schematic drawings, in which:

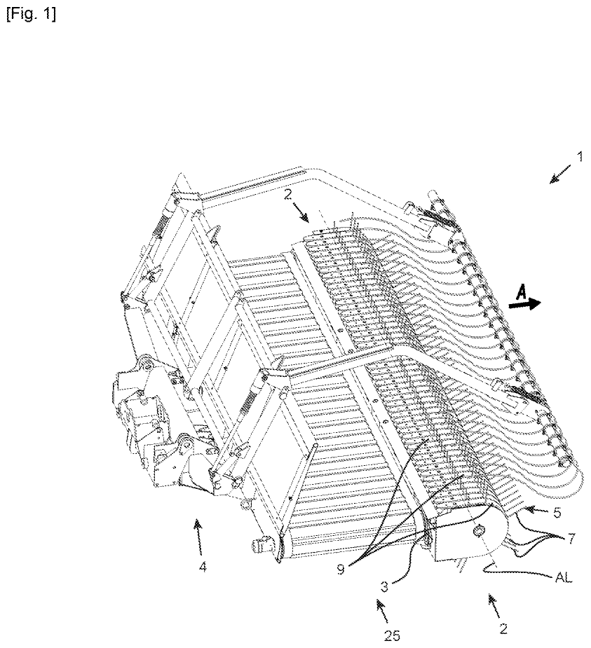

FIG. 1 is a perspective view of an example of an agricultural machine according to the invention;

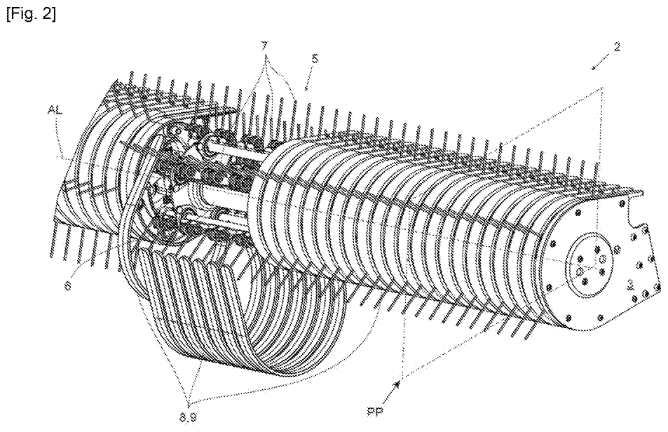

FIG. 2 is a partial perspective view of a collection device according to the invention which may be part of the machine shown in FIG. 1, where some deflectors are in the mounted state and some in the disengaged state (one of which is currently being disengaged);

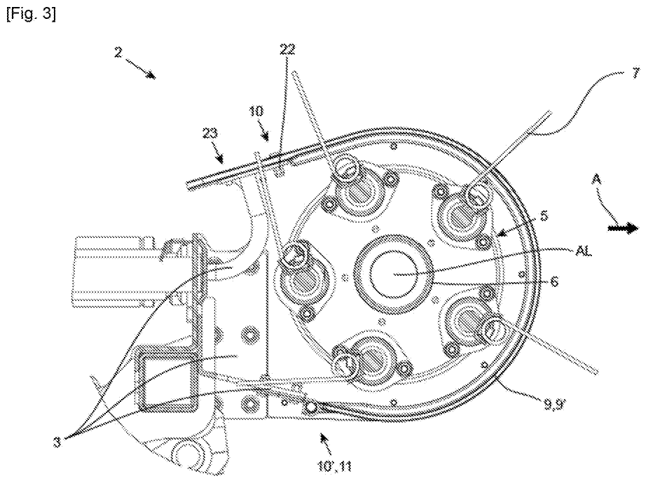

FIG. 3 is a partial cross-sectional view in a plane perpendicular to the longitudinal axis of the rotor of a collection device as shown in FIG. 1 and FIG. 2, in relation to a first embodiment of the invention (deflector in mounted state);

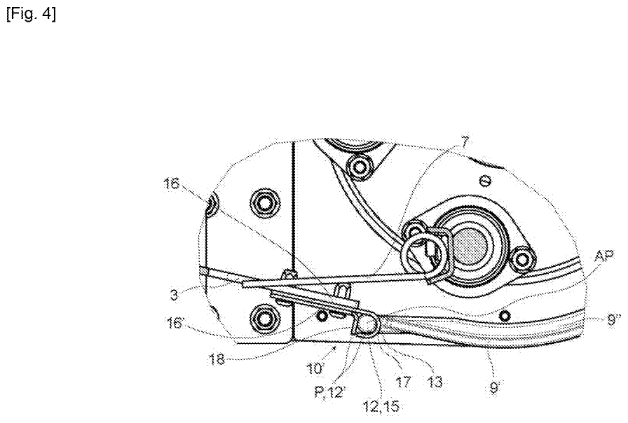

FIG. 4 is a detailed view, in a plane perpendicular to the longitudinal axis of the rotor and on a different scale, of the articulated connection connecting a deflector with the frame (and forming an additional means of attachment), in accordance with the design of the collection device shown in FIG. 3 (deflector in the mounted state);

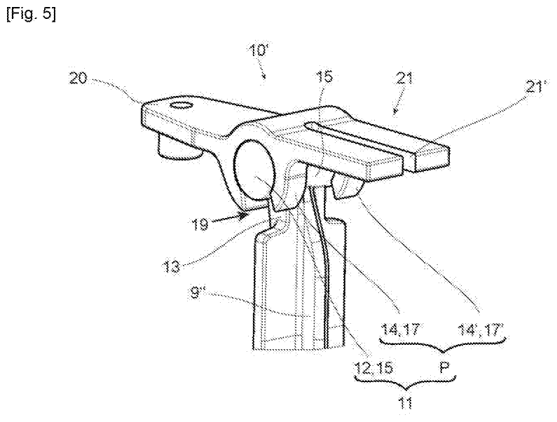

FIG. 5 is a perspective view of the articulated connection connecting a deflector with the frame (and forming an additional means of attachment), in accordance with a second embodiment of the collection device (deflector in the disengaged state);

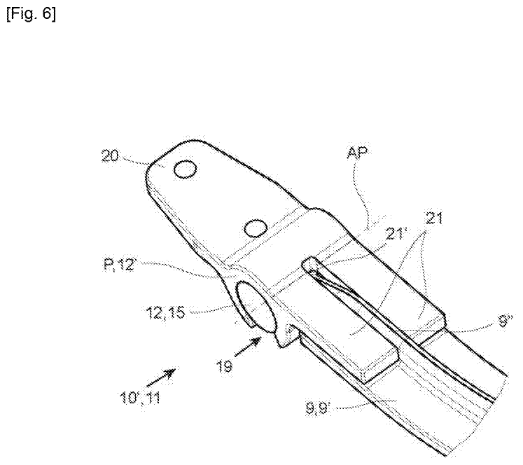

FIG. 6 is a perspective view in another direction of the articulated connection shown in FIG. 5 in a deflector configuration corresponding to its mounted state;

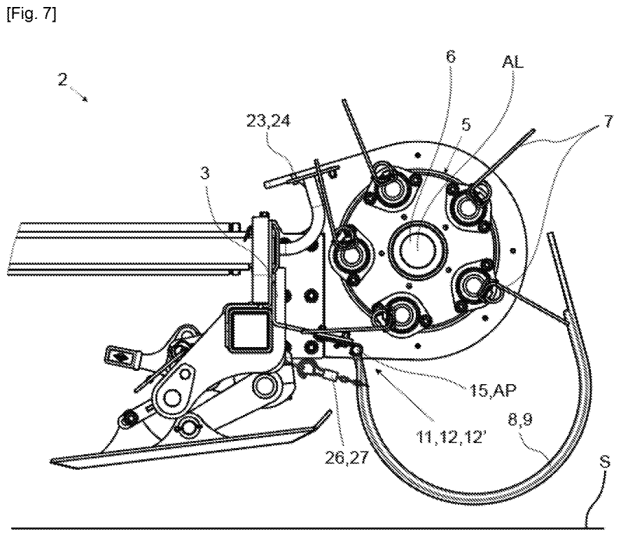

FIG. 7 is a view similar to that in FIG. 3 illustrating a position of the deflector(s) after detachment of the singular or plural means of attachment (in particular the first means of attachment), in the disengaged state of the deflector(s), and

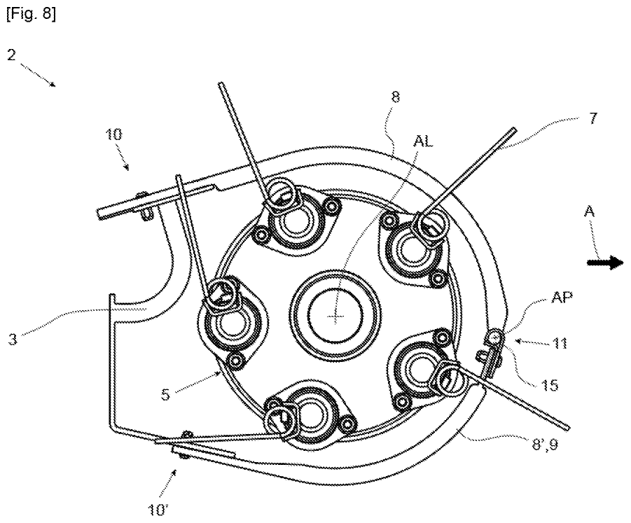

FIG. 8 is a partial cross-sectional view in a plane perpendicular to the longitudinal axis of rotation of the rotor of a collection device, in relation with a variant of the invention (deflectors in the mounted state).

FIG. 1, and partially FIG. 7, illustrate an agricultural cut plant processing machine 1, in particular a harvesting machine, comprising at least a collection device 2, preferably for plants such as grass or straw.

This device 2 comprises a frame 3, preferably connected to the base frame 4 of machine 1. This device 2 comprises, on the one hand, in addition to frame 3, an elongated rotor 5 which can be driven in rotation relative to frame 3 about a longitudinal axis AL. The rotor 5 may comprise a central shaft 6 guided in rotation about the longitudinal axis AL, preferably by means of bearings and/or ball bearings. The longitudinal axis AL is substantially horizontal, and preferably transverse, or substantially perpendicular to the direction of travel A of the device 2 and/or machine 1 during operation. A plurality of raking tines 7 arranged in groups of three, or more, are mounted on the rotor 5. The tines 7 are arranged around the shaft 6 of the rotor 5, being mounted on supports forming part of the rotor 5. The tines 7 are mounted rotatably around the longitudinal axis AL. The direction of rotation of the rotor 5, or of the tines 7, is preferably such that at the lower part of rotor 5, the tines 7 move forward. Each group of tines 7 is situated in its own plane PP perpendicular to this longitudinal axis AL, these different planes PP being arranged along the said longitudinal axis AL, preferably at regular intervals.

On the other hand, device 2 comprises a plurality of deflectors 9, preferably in the form of curved bodies 9′, extending at least partially around rotor 5 and spaced out in the direction of the longitudinal axis AL. The deflectors 9 thus extend in planes PP, perpendicular to the longitudinal axis AL, preferably arranged parallel to each other. The spacing between two adjacent deflectors 9 is adapted for the passage of the tines 7 of a group during rotation of the rotor 5, and said deflectors 9 are, in the mounted state, connected to the frame 3, preferably in a rigid manner, by means of at least one first means of attachment 10.

In accordance with the invention, at least one movable part 8 of at least one of the deflectors 9 is connected to the frame 3, or to a fixed part 8′, by an articulated connection 11 which allows the said movable part 8 at least a swiveling motion resulting in disengagement from the rotor 5. The movable part 8 is thus configured to swivel with respect to frame 3. More precisely, said articulated connection is arranged and configured in such a way that after detachment of the first means of attachment, at least the movable part of the concerned deflector can be swiveled about a swivel axis so that the deflector(s) in question is/are in a disengaged state.

Thanks to the invention, by sufficiently spreading out at least a movable part 8 of the or each deflector 9 of rotor 5, it is possible to intervene on said rotor 5 without dismantling the deflector(s) 9 in question. The or each deflector 9 remains attached to the device 2, preferably together with the movable part 8, which makes it possible to attach the said at least first means of attachment 10 more easily and quickly. It is then easier and quicker to replace the said deflector 9 in the mounted state on device 2. This design significantly reduces the intervention time on the rotor 5.

As shown in FIG. 3 to FIG. 8, and at least in the mounted state, the or each deflector 9 is additionally connected to frame 3 by an additional means of attachment 10′ or second means of attachment of the relevant deflector 9. This additional means of attachment makes it possible to consolidate and rigidify the securing of the deflector 9 to frame 3.

In a preferred embodiment, the articulated connection 11 forms the additional means of attachment 10′ of the or each deflector 9 to the frame 3, at least in its mounted state and preferably also in the disengaged state. Thus, the articulated connection 11 allows the disengagement of at least the movable part 8 of the deflector 9 from the rotor 5, while at the same time allowing the consolidation of the securing of the deflector 9 to the frame 3. Such a design also makes it possible to simplify the manufacture of the articulated connection 11 and/or of the deflector 9.

In a preferred embodiment, the or each deflector 9 consists of a curved body 9′, preferably in one piece. The body 9′ is advantageously C-shaped or U-shaped, preferably open towards the rear. The outer wall of the body 9′ thus provides a convex strip-shaped surface. The articulated connection 11 is preferably located close to one of the two ends of the body 9′, so that the distance and thus the clearance to rotor 5 is large. In addition, the movable part 8 advantageously constitutes the entire deflector 9 in question, allowing even greater clearance after swiveling and simplifying the manufacture and assembly of the deflector 9.

In this description, except where otherwise noted, the terms “front”, “rear”, “in front” and “behind” are defined by looking in the direction of travel A. In addition, in this description, unless otherwise specified, the indications concerning the or each deflector 9 are given when said deflector 9 is in the mounted state.

The first means of attachment 10 is located in proximity of the other one of the two ends of the body 9′ of the or each deflector 9 in relation to the additional means of attachment 10′. According to another interesting feature, the first means of attachment 10 is located in the proximity of the other of the two ends of body 9′ of the or each deflector 9 in relation to the articulated connection 11. It is thus possible to provide substantial access to rotor 5 at the deflector(s) 9 concerned, in particular in the maximum disengaged state, without having to dismantle the latter, in particular without having to release or detach the additional means of attachment 10′ (preferably combined with the articulated connection 11).

In side view, a deflector 9 in question, comprises at least one curved part, preferably forming an arc of a circle centered on the axis AL. Each deflector 9, as a whole, forms a C, the opening of which is preferably oriented towards the rear (in relation to the direction of travel A of machine 1 in question). The outer wall of a deflector 9 forms a convex surface intended to guide the cut plants when the same are engaged by the tines 7. Advantageously, the deflector 9 has a lower horizontally extending branch located at least partially below the rotor 5. The lower branch forms a curve whose center of curvature is preferably higher than the said lower part. The deflector 9 also comprises a vertically extending front part, located at least partly at the front of rotor 5 and forming a curve whose center of curvature is preferably behind the front part. The deflector 9 also comprises an upper branch preferably extending substantially horizontally, located at least partially above rotor 5 and forming a curve whose center of curvature is preferably below said upper branch.

As shown in FIG. 3, the articulated connection 11 is preferably located at the lower end of body 9′, in the mounted state of the deflector 9 in question. Alternatively, and as shown in FIG. 8, the articulated connection 11 can be located at the front end of body 9′, in the mounted state of the deflector 9 in question. The first attachment 10 is located, in the mounted state of the deflector 9 in question, at the upper end of the deflector 9, or of the body 9′. One advantage of this construction is that no intervention is required in the lower area of the said deflector 9 or of the device 2, which is generally more difficult to access. In the disengaged state, it is thus possible to work on device 2 from above, which is easier and more ergonomic. Moreover, gravity is advantageously used to open and/or maintain the deflector 9 in question in a disengaged state. A tether 26 can also be provided to hold the movable part 8 in at least one disengaged state, and preferably in several disengaged states. In particular, the tether 26 may allow the deflector 9 to remain in the maximum disengaged state. Thus in at least one disengaged state, and preferably at least in the maximum disengaged state, the movable part 8 is in a stable position of equilibrium. This equilibrium can be ensured by means of gravity and/or the tether 26. It is therefore advantageously not necessary to manually hold the deflector 9 or the movable part 8 in question. This holding in position also provides additional safety. The tether 26 can be made with one or a plurality of small chain(s) 27. It should be noted that, even in the case where the articulated connection 11 is located at the upper end of the body (9′), in the mounted state of the deflector (9) in question, with a tether 26 allowing the corresponding movable part 8 to be kept in equilibrium, it is not necessary to maintain the latter, nor to dismantle it, which facilitates and shortens an intervention on the rotor 5, especially as the number of deflectors (9) is large.

In accordance with a first construction variant, wherein the deflector 9 is allowed additional degrees of freedom following the unfastening of the first means of attachment 10, which is however not part of the invention, the articulated connection 11 can be a ball joint connection.

However, and according to a second preferred constructive variant and in accordance with the invention, which is simpler and more economical, the articulated connection 11 is a swivel connection with a swivel axis AP preferably oriented substantially parallel to the longitudinal axis AL of rotor 5 (see FIG. 3). Such a design allows the movable part 8 to be fixed at all degrees of freedom, except for rotation about the axis AP. In this case, the swivel axis AP of the articulated connection 11 can be formed by a rod 15 housed in a bearing P.

Preferably, the first means of attachment 10 is, alone, capable of obstructing all the degrees of freedom of the deflector 9 in question, in relation to frame 3. In addition, at least one of the means of attachment 10 and additional means of attachment 10′ is located so as to be accessible from the outside, preferably at the outer wall of the deflector 9. In addition, at least one of the first means of attachment 10 and the additional means of attachment 10′ is of the detachable type, preferably both means 10 and 10′.

In the preferred embodiment, the first means of attachment 10 includes screw connection 22. Preferably, screw connection 22 is achieved by a screw in engagement with an integral thread of the frame 3 in the mounted state of the deflector 9 in question. According to this embodiment, the detachment of the screw connection 22, or of the first means of attachment 10, is achieved by unscrewing the screw from the thread, so that they are no longer in engagement. The attachment and/or detachment of screw connection 22 is quick and easy. In addition, since screw connection 22 assures attachment by tensioning, the hole through the deflector 9 for the screw does not have to be machined with any particular precision. Another advantage of screw connection 22 as a means of attachment 10 and/or 10′ is that it is possible to countersink it, i.e. it does not protrude from the deflector 9. It is also advantageous to choose a countersunk screw and/or a countersunk nut. The outer wall of each deflector 9 thereby remains smooth so that no forage can become hooked up on it. Alternatively, this means of attachment 10 could be made by rivet, or by pin possibly made of elastomer or rubber material inserted by elasticity in a hole in the deflector 9 and frame 3.

As shown by way of example in FIG. 3 to FIG. 8, when the two means of attachment 10 and 10′ are attached, they secure the or each deflector 9 in question to the frame 3, the said deflector 9 is then in the mounted state, i.e. in its operational configuration. After detachment of the first means of attachment 10, the or each deflector 9 in question is in the disengaged state. In the disengaged state of deflector 9, the movable part 8 remains connected to frame 3, preferably by the additional means of attachment 10′. The movable part(s) 8 in question thus remain(s) connected to frame 3, even in the maximum disengaged state. Consequently, it is not necessary to worry about the deflector(s) 9 in the disengaged state (no storage of parts 8 or body 9′ of deflector). Furthermore, it is impossible to lose a deflector 9 or a movable part 8, in the disengaged state. This advantageously reduces the number of actions to be carried out to access rotor 5, and thus implies a quicker intervention. After detachment of the first means of attachment 10, at least the movable part 8, and preferably the entire deflector 9 in question, can be rotated around the swivel axis AP. This swiveling is carried out manually, by exerting torque on the movable part 8 around the axis AL, preferably oriented in the direction opposite to the rotation of the rotor 5, or of the tines 7. After the said swiveling, the deflector 9 occupies a more or less spread out and thus more or less free state. In the disengaged state, only one of the first means of attachment 10 and the additional means of attachment 10′ is attached, and preferably only the articulated connection 11 forming the additional means of attachment 10′. In the disengaged state, the or each deflector 9 either does not cover or only partially covers the rotor 5. In the disengaged state (Cf. FIG. 7), the deflector 9 always covers less of rotor 5 than in the mounted state. In the configuration corresponding to the maximum disengaged state, at least one quarter of the outer surface of rotor 5 or the circumference of rotor 5, is preferably disengaged. After a certain swivel angle, preferably corresponding to its maximum disengaged state, the deflector 9 in question can be moved in the direction of the swivel axis AP so that it can be removed from device 2.

In accordance with preferred constructions of device 2, it can be provided that in the mounted state, the said at least one deflector 9 surrounds the rotor 5 over at least half, advantageously over at least ⅔, preferably over at least ¾, of its circumference as seen along the longitudinal axis AL. In the maximum disengaged state of said deflector 9, at least 20% of the circumference of the rotor 5, preferably at least between 25% and 30% of said circumference, is disengaged.

According to another feature of the invention, in particular as shown in FIG. 3 and FIG. 7, the or each articulated connection 11 is configured and/or arranged to allow a rotation of at least 45°, advantageously at least 50°, preferably at least 60°, and even more preferably at least 75°, of the movable part 8 about the swivel axis AP (between the mounted position and the position in the maximum disengaged state of the deflector 9 in question, preferably downwards). The greater the swivel range, the greater the disengagement and the easier intervention becomes. Frame 3 and the at least one deflector 9 are also configured and/or arranged to allow these rotations.

In accordance with the preferred embodiment, in the mounted state, a centering means 23, preferably detachable, allows the or each deflector 9 to be positioned on frame 3. This centering means 23 allows the assurance of a proper orientation of the or each deflector 9 parallel to its own perpendicular plane PP. In the preferred embodiment, the centering means 23 is located close to the first means of attachment 10.

The centering means 23 can comprise a teat 24, preferably integral to frame 3. In the mounted state of the deflector 9, the teat 24 is inserted in a hole preferably made at one end of the said deflector 9. Detachment of the centering means 23 is achieved by moving the ends of the deflector 9 away from each other after detachment of the means of attachment 10.

In the alternative embodiment shown in FIG. 8, the articulated connection 11 is located between the first means of attachment 10 and the additional means of attachment 10′ (along the body 9′ of the deflector 9). In this embodiment, the fixed part 8′ remains rigidly attached to the frame 3, preferably by the additional means of attachment 10′, during the swiveling movement of the movable part 8 around the articulated connection 11, preferably after detachment of only (any) one of the means of attachment 10, 10′, and preferably of the first means of attachment 10. Only the movable part 8 is moved apart/disengaged from rotor 5.

In order to achieve a lightweight and inexpensive construction, the said at least one deflector 9 can be made of a thermoplastic material (examples of possible materials: PA6 or HDPE), in the form of a thermoformed or injection-molded part. Such a material can be easily deformed, at least elastically, and even manually. In addition, at least one structural reinforcement rib 9″ is formed on the inner side (opposite the outer wall) of the body 9′. Preferably all deflectors 9 are made in this way.

In order to achieve a reduction in the number of necessary parts and an easy and economical manufacture of the articulated connection 11, the latter may be made up of two complementary components 12 and 12′ that cooperate with one another. A first component 12 is integrated into the movable part 8 in question, or to the deflector 9 in question. A second component 12′ is integral to the fixed part 8′, or to the frame 3.

In the embodiment illustrated in particular in FIG. 6, the first component 12 is made up of a rod 15. The rod 15 forms the swivel axis AP of the articulated connection 11, preferably made by a swivel. In the examples illustrated, the rod 15 is formed integrally with the body 9′ of the deflector 9 in question, and preferably constitutes the lower end of the said body 9′ in the mounted state of the deflector 9 in question. As shown in FIG. 7 and FIG. 8, the rod 15 is part of the movable part 8.

As can be seen from FIG. 3 to FIG. 6, rod 15 can be advantageously connected to the body 9′ by a constriction 13, preferably of restricted width.

The second component 12′ is a bearing P. The bearing P accommodates the rod 15 with guidance. This guidance of the swivel connection prevents jamming, e.g. due to an approximate manual guidance of the swiveling of the deflector 9, or of the movable part 8. The guidance of the rod 15 by the bearing P also reduces the required swiveling force. The bearing P can comprise two bearing parts 14 and 14′, each cooperating with one of the two rod portions 15 extending as a protrusion beyond the constriction 13. These two bearing parts 14 and 14′ allow movement of the constriction 13 between them, at least over a limited angle of travel of the deflector 9.

Therefore, in the mounted state of deflector 9 (optimum configuration or adapted to work requirements), the two bearing parts 14 and 14′ located side by side with spacing receive the constriction 13 between them. The bearing parts 14 and 14′ thus block the deflector 9 at all degrees of freedom at the additional means of attachment 10′ apart from rotation about the swivel axis AP.

According to another advantageous feature of the invention, illustrated in particular by FIG. 5 and FIG. 6, at least one of the two bearing parts 14, 14′ has an opening 19 configured to allow the passage of the deflector 9 in question, or of the constriction 13, by sliding in the direction of the swivel axis AP when the deflector 9 is in the maximum disengaged state.

This opening 19, in the form of an axial slot, is configured and located so that, when the deflector is in the maximum disengaged state, the constriction 13 is not located between the bearing parts 14, 14′. Rod 15 can then slide into the bearing P according to the swivel axis AP in order to assemble or disassemble the deflector to device 2. This arrangement allows the deflector 9, preferably at its lower end, to be assembled and disassembled simply, quickly and without the use of tools. The assembly and disassembly actions of a deflector 9 are thus advantageously shortened.

In accordance with a first construction variant, illustrated in particular in FIG. 4, the second component 12′, or the bearing P, is composed of two mutually cooperating flanges 16, 16′, assembled together with each other and with frame 3. The first flange 16 has two spaced-apart curved hooks 17, 17′. The second flange 16′ has at least one blade 18 configured to close the openings of the two hooks 17, 17′ so as to form with them the two bearing parts 14, 14′.

In accordance with a second construction variant, illustrated in FIG. 5 and FIG. 6, the second component 12′, or the bearing P, consists of a part, preferably made of metal, comprising two annular rings 17, 17′. The bearing P is formed in one piece with a preferably detachable mounting plate 20 which can be attached to the frame 3 by one or more fastening means.

The invention can thus provide that the bearing P also comprises, at the two hooks 17, 17′ of the first flange 16 or the two rings 17, 17′ of the molded part, an extension in the form of a wing 21 with a slot-shaped cutout 21′, or two wings spaced apart by a slot-shaped gap 21′. The slot 21′ preferably receives an end portion of the reinforcing rib 9″ in an adjusted manner when the deflector 9 in question is in the mounted state. The wing 21 or the two spaced out wings additionally form(s) an abutment for the said deflector.

This results in an additional locking of the deflector 9 in the direction of the axis AL and an additional rotational locking at the articulated connection 11, preferably around the swivel axis AP (in addition to the locking resulting from the connection of the first means of attachment 10).

If necessary, if there is a privileged area for intervention on the rotor 5, a single deflector 9 assembled to frame 3 by an articulated connection 11 may be sufficient, the other deflectors being then attached in the traditional manner to the said frame (for example, the same type of fasteners which may or may not be separable at the top and bottom).

According to an alternative embodiment, all or some of the deflectors 9 are rigidly connected to each other. Together they make up a component forming a partially open cylindrical enclosure around the rotor 5. The movable part 8, connected to frame 3 by means of the articulated connection 11, can be in common for the deflectors 9 forming the said component. In a specific variant of this embodiment, the movable part 8 comprises all the deflectors 9. The swiveling movement of the movable part 8 thus causes a simultaneous disengagement of all the deflectors 9 from rotor 5, preferably over the entire width of the said rotor 5.

Nonetheless, advantageously, several deflectors 9 (according to the invention) located side by side to disengage at least a longitudinal part of the rotor 5 or arranged alternatingly with conventionally-attached deflectors, are provided at device 2.

Lastly, all deflectors 9 are preferably attached to frame 3 in accordance with the provisions of the invention. Moreover, all the deflectors 9 are preferably identical, allowing a standardized production, in large series and thereby a reduction in cost. Thus, in the preferred embodiment, each deflector 9 is connected to frame 3 by its own articulated connection 11. Furthermore, according to the preferred embodiment, each deflector can thereby be independently disengaged from the other deflectors 9. The disengagement from rotor 5, which is induced by the swiveling of a deflector 9, is thereby partial. According to the preferred embodiment, the disengagement in relation to rotor 5 over the entire width of rotor 5 is achieved by pivoting all the deflectors 9.

The invention also relates to an agricultural machine 1 for processing cut plants, in particular a harvesting machine, comprising at least one collection device 2, the said device 2 being of the type described above. Machine 1 may be of the mounted or pulled type, with a means of attachment to a tractor, or even self-propelled. Device 2, or machine 1, can be supported on the ground S by wheels or skids, preferably located behind rotor 5 when seen in the direction of travel.

Device 2 can be set in a working position in which the tines 7 are close to the ground S and suitable to rake the plants lying there. In this position, the longitudinal axis AL is elongated and/or substantially parallel to the ground S. Device 2 may likewise be in a raised position (FIG. 7) so that at least the movable part 8 of the or each deflector 9 can be swiveled at a significant angle to the ground S into the disengaged position.

On machine 1 illustrated in FIG. 1, when looking in the direction of travel A, a conveyor belt 25 is fitted behind the collection device 2 to move the plants transversely to the direction of travel A, so that they can be laid out in swaths. Conveyor 25 receives the plants projected to the rear by collection device 2. During operation, device 2 is in the operational position and the rotor 5 is driven in rotation about the longitudinal axis AL.

The subject matter of the invention also relates, as illustrated in FIG. 3, FIG. 7 and FIG. 8, to a deflector 9 for a collection device 2 as described above, this deflector 9 comprising a movable part 8 with a single-piece rod and configured to be connected to the frame 3 of the collection device 2 by an articulated connection 11, whose swivel axis AP is formed by the aforementioned rod 15 and which allows the said movable part 8 at least one swiveling movement resulting in disengagement from rotor 5 of the said collection device 2.

The subject matter of the invention furthermore relates to a method for at least partially disengaging at least rotor 5 from a collection device 2.

In this context, the invention also proposes a method of at least partially disengaging an elongated rotor 5 from a collection device 2 of an agricultural machine 1 for processing cut plants, the said collection device 2 comprising, on the one hand, a frame 3 and a rotor 5 able to be induced in rotation relative to the frame 3 about a longitudinal axis AL, a plurality of raking tines 7 arranged in groups of three or more being mounted on rotor 5, each group of tines 7 being located in its own plane PP perpendicular to the longitudinal axis AL, these different planes PP being arranged along said longitudinal axis AL, and, on the other hand, a plurality of deflectors 9 extending at least partially around rotor 5 and spaced out in the direction of the longitudinal axis AL, the spacing between two adjacent deflectors 9 being adapted for the passage of the tines 7 of a group during rotation of rotor 5, and said deflectors 9 being, in the mounted state, connected to frame 3 by at least a first means of attachment 10.

This process is characterized in that, in order to at least partially disengage rotor 5, it consists in detaching the said at least first means of attachment 10, then in swiveling the said at least one movable part 8, or the whole, of at least one deflector 9 about an articulated connection 11 connecting this deflector 9 with the frame 3, resulting in a disengagement in relation to rotor 5. Advantageously, the at least one movable part 8, or the entire body 9′, of at least one deflector 9 is swiveled downwards. Preferably, in order to reach the maximum disengaged state of a deflector 9, its movable part 8, or the entire body 9′ is swiveled at an angle between 45° and 250°, more preferably between 60° and 180°.

More specifically and in relation to the attached figures, the said at least first means of attachment 10 is first detached in order to at least partially disengage rotor 5 from the collection device 2. If necessary, it may be required to disengage the centering means 23 from the deflector 9 in the assembled state, preferably, following the detachment of the first means of attachment 10. In the example of an embodiment with several first means of attachment 10 by deflector 9 or movable part 8, it is necessary to detach them all. The movable part 8 or the whole of deflector 9 is then rotated around the articulated connection 11 or the swivel axis AP, preferably in the direction opposite to that of rotation of the raking tines 7 when the rotor 5 is induced in rotation. This swiveling induces a disengagement from rotor 5. The deflector 9 is then in the disengaged state. In order to achieve a greater disengagement of rotor 5, it is advantageous to be able to swivel at least one deflector 9 at an angle of between 45° and 180°. In the preferred embodiment, several or all of the deflectors 9 are moved from the mounted state to the disengaged state in the manner described above in order to disengage a substantial part of rotor 5. In order to move the or each deflector 9 from the disengaged state to the mounted state, the above-mentioned steps are carried out in the reverse order.

In the preferred embodiment, in order to remove the deflector 9 from frame 3, the entire deflector 9 is rotated about the swivel axis AP until it can be slid along the swivel axis AP. The deflector 9 is then displaced along the swivel axis AP, preferably through an opening 19 provided for this purpose, until the deflector 9 is removed (from frame 3). In the preferred embodiment, in order to mount the deflector 9 on frame 3, the above steps are carried out in the reverse order.

Of course, the invention is not limited to the embodiments described and represented in the appended drawings. Modifications remain possible, in particular from the point of view of the composition of the various elements or by substitution of technical equivalents, this without however expanding beyond the scope of protection of the invention.

1. A collection device comprising a frame and an elongated rotor guided in rotation relative to the frame about a longitudinal axis, a plurality of raking tines arranged in groups of three or more being mounted on the rotor, each group of tines being located in its own plane perpendicular to the longitudinal axis, these different planes being arranged along the said longitudinal axis, and a plurality of deflectors extending at least partially about the rotor and spaced out in the direction of the longitudinal axis, the spacing between two adjacent deflectors being adapted for the passage of the tines of a group during the rotation of the rotor, and the said deflectors in the mounted state being connected to the frame by the intermediary of at least one first means of attachment, wherein at least one movable part of at least one of the deflectors is connected to the frame, or to a fixed part of a deflector, by means of an articulated connection which allows the said movable part at least a swiveling movement inducing a disengagement in relation to the rotor, the said articulated connection which is arranged and configured in such a manner that following detachment of the first means of attachment, at least the movable part of the deflector in question can be swiveled about a swivel axis so that the or each deflector in question is found to be in a disengaged state.

2. The device according to claim 1, wherein the or each deflector is moreover connected to the frame by an additional means of attachment.

3. The device according to claim 2, wherein the articulated connection forms the additional means of attachment of the or each deflector to the frame.

4. The device according to claim 1, wherein the or each deflector consists of a curved body, the or each articulated connection being located in the proximity of one of the two ends of the said body .

5. The device according to claim 4, wherein the first means of attachment is located in the proximity of the other of the two ends of the body of the or each deflector, in relation to the articulated connection.

6. The device according to claim 1, wherein the articulated connection is located at the lower end of the body, in the mounted state of the deflector in question.

7. The device according to claim 1, wherein the articulated connection is a swivel connection with a rotational axis substantially oriented parallel to the longitudinal axis of rotor. the swivel axis of the articulated connection is formed by a rod housed in a bearing.

9. The agricultural machine for processing cut plants, in particular a harvesting machine, wherein it comprises at least one collection device according to claim 1.

10. The deflector for a collection device according to claim 1, wherein it comprises one movable part with a one-piece rod and configured to be connected to the frame of the collection device by an articulated connection the swivel axis AP of which is formed by the aforementioned rod and which allows a swiveling motion of the said movable part leading to disengagement from the rotor of the said collection device.

11. A method of at least partial disengagement of an elongated rotor of a collection device of an agricultural machine for processing cut plants, the said collection device comprising a frame and a rotor able to be rotated in relation to the frame about a longitudinal axis, a plurality of raking tines arranged in groups of three or more being mounted on the rotor, each group of tines being located in its own plane perpendicular to the longitudinal axis, these different planes being laid out along the said longitudinal axis, and a plurality of deflectors extending at least partially about the rotor and spaced out in the laid out along the said longitudinal axis, and a plurality of deflectors extending at least partially about the rotor and spaced out in the direction of the longitudinal axis, the spacing between two adjacent deflectors being adapted for the passage of the tines of one group during rotation of rotor, and in the mounted state, the said deflectors being connected to frame by the intermediary of at least a first means of attachment, a method wherein to at least partially disengage the rotor, it consists of detaching the said at least first means of attachment, and to then swivel the said at least one movable part, or the whole, of at least one deflector about an articulated connection connecting this deflector to the frame, inducing a disengagement in relation to rotor.

12. The method for disengagement according to claim 11, wherein the at least one movable part, or the entirety of the body, of at least one deflector, is swiveled towards the bottom in view of disengaging rotor.

13. The method for disengagement according to claim 11, wherein, to achieve the maximum disengaged state of a deflector, its movable part, or the entirety of its body, is swiveled at an angle of between 45° and 250°, more preferably between 60° and 180°.
